(19) United States
(12) Patent Application Publication
(10) Pub. No.: US 2023/0217513 A1
(43) Pub. Date: Jul. 6, 2023

(54) SYSTEM AND METHOD FOR SWITCHING DATA SESSION IN USER EQUIPMENT WITH DUAL SIM IN A WIRELESS COMMUNICATION SYSTEM

(71) Applicant: Samsung Electronics Co., Ltd., Suwon-si (KR)

(72) Inventors: Danish Ehsan HASHMI, Bangalore (IN); Jagadeesh GANDIKOTA, Bangalore (IN); Brijendra Kumar ASTHANA, Bangalore (IN); Jyotimoy KARJEE, Bangalore (IN); Abhishek TIWARI, Bangalore (IN)

(21) Appl. No.: 18/094,095

(22) Filed: Jan. 6, 2023

(30) Foreign Application Priority Data
Jan. 6, 2022 (IN) 202241000857
Dec. 6, 2022 (IN) 202241000857

(51) Int. Cl. H04W 76/11; H04W 28/02; H04W 8/20

(52) U.S. Cl. CPC H04W 76/11; H04W 28/0268; H04W 8/20; H04W 88/06

(57) ABSTRACT

The disclosure relates to a 5G or 6G communication system for supporting a higher data transmission rate. For example, the disclosure relates to a method for switching a data session for an application, implemented in a user equipment with dual SIM. The method includes: determining a User Equipment (UE) Route Selection Policy (URSP) rule for a primary Subscriber Identity Module (SIM) and a secondary SIM. The method includes detecting a trigger for switching the data session of the application to the secondary SIM based on determination of the URSP rule, wherein the trigger includes one of a matching traffic descriptor, a dedicated network slice, a Quality of Service (QoS) rule and a user preference. The method includes configuring the secondary SIM for the DDS based on the trigger; and switching the data session of the application to the secondary SIM for continuing the data session.

### CROSS-REFERENCE TO RELATED APPLICATIONS

This application is based on and claims priority under 35 U.S.C. § 119 to Indian Provisional Patent Application No. 202241000857, filed on Jan. 6, 2022, in the Indian Patent Office, and to Indian Complete Patent Application No. 202241000857, filed on Dec. 6, 2022, in the Indian Patent Office, the disclosures of all of which are incorporated by reference herein in their entireties.

### BACKGROUND

### 1. Field

The disclosure relates to data handling in fifth generation (5G) network, and for example, the disclosure relates to switching data in a user equipment with multi-SIM environment using multi-slice in a wireless communication system.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources

### SUMMARY

According to an example embodiment of the present disclosure, a method for switching a data session for an application in Fifth Generation Cellular Network (5G) by a User Equipment (UE) with dual SIM is disclosed. The method includes: determining a User Equipment Route Selection Policy (URSP) rule for a primary Subscriber Identity Module (SIM) and a secondary SIM, wherein the primary SIM is configured as a Default Data Subscription (DDS) providing the data session for the application running on the UE; detecting a trigger for switching the data session of the application to the secondary SIM based on determination of the URSP rule, wherein the trigger includes one of a matching traffic descriptor, a dedicated network slice, one or more stored Quality of Service (QoS) rule and a user preference; configuring, the secondary SIM for the DDS based on the trigger; and switching the data session of the application to the secondary SIM for continuing the data session in response to the configuration.

According to an example embodiment of the present disclosure, a system for a data session switching for an application in Fifth Generation Cellular Network (5G) by a User Equipment (UE) with dual SIM is disclosed. The system includes: a processor configured to: determine a User Equipment Route Selection Policy (URSP) rule for a primary Subscriber Identity Module (SIM) and a secondary SIM, wherein the primary SIM is configured as Default Data Subscription (DDS) providing the data session for the application running on the UE; detect a trigger for switching the data session of the application to the secondary SIM based on determination of the URSP rule, wherein the trigger includes one of a matching traffic descriptor a dedicated network slice, one or more stored Quality of Service (QoS) rule and a user preference; configure, the secondary SIM for the DDS based on the trigger; and switch the data session of the application to the secondary SIM for continuing the data session in response to the configuration.

Example advantages and features of various example embodiments of the present disclosure, are provided in the following detailed description and will be explained with reference to various example embodiments, which are illustrated in the appended drawings. It is appreciated that these drawings depict example embodiments of the disclosure and are therefore not to be considered limiting of its scope. The disclosure will be described and explained with additional specificity and detail with reference to the accompanying drawings.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an application using a primary SIM for a data session in fifth-generation cellular network, according to various embodiments;

FIG. 2 is a block diagram illustrating an example environment of implementation, according to various embodiments;

FIG. 3 is a flowchart illustrating an example method for switching the data session for the application in Fifth Generation Cellular Network (5G) by the User Equipment (UE) with dual SIM, according to various embodiments;

FIG. 4 is a flowchart illustrating example operations for switching the data session of the application using the dedicated network slice, according to various embodiments;

FIG. 5 is a flowchart illustrating example operations for switching the data session of the application to the secondary SIM based on matching traffic descriptor, according to various embodiments;

FIG. 6 is a flowchart illustrating example operations for switching the data session of the application to the secondary SIM based on stored Quality of Service (QoS) rule, according to various embodiments;

FIG. 7 is a flowchart illustrating example operations for switching the data session of the application based on the predefined preference of the user, according to various embodiments;

FIG. 8 is a flowchart illustrating an example method for switching the data session of the application to the primary SIM based on the matching traffic descriptor, according to various embodiments;

FIG. 9 is a flowchart illustrating an example method for assigning a binary value to each of the primary SIM and the secondary SIM for switching the data session of the application, according to various embodiments;

FIG. 10 is a block diagram illustrating an example system architecture according to various embodiments;

FIG. 11 is a block diagram illustrating an example system architecture, according to various embodiments;

FIG. 12 is a block diagram illustrating an example configuration of a UE according to various embodiments;

FIG. 13 is a block diagram illustrating an example configuration of a base station according to various embodiments; and

FIG. 14 is a block diagram illustrating an example configuration of a network entity according to various embodiments.

### DETAILED DESCRIPTION

A fifth generation (5G) network, a user equipment (UE) may be provisioned with a User Equipment Route Selection Policy (URSP) rules. The URSP rules provides information on which Protocol Data Unit (PDU) session on a network slice a given service or an application should use when the same is activated. Particularly, 5G define URSP rules to route data from the application through specific Data Network Names (DNN), slice. The UE may receive the URSP rules by a home Public Land Mobile Network (PLMN) Policy Control Function. An operator may have the ability to manage slices using the URSP rules. The URSP rules may enable UE to automatically switch between different network slices according to the application running on the UE. For instance, the UE working for a financial institution might require a highly secure network slice for sending and receiving sensitive corporate data. Such network slice should be a reliable, high-throughput, low-latency slice so that the UE may participate in a video meeting.

In the UE with a multiple Subscriber Identity Module (SIM), the application may be connecting with either one of the multiple SIM present in the UE for a data session. As discussed above, each of the multiple SIM may have the URSP rule received by the PLMN for providing the data session to the applications installed in the UE.

Further, skilled artisans will appreciate that elements in the drawings are illustrated for simplicity and may not have necessarily been drawn to scale. For example, the flowcharts may illustrate the method in terms of operations involved to improve understanding of aspects of the present disclosure. Furthermore, in terms of the construction of the device, one or more components of the device may have been represented in the drawings by conventional symbols, and the drawings may show details that are pertinent to understanding the embodiments of the present disclosure so as not to obscure the drawings with details that will be readily apparent to those of ordinary skill in the art having the benefit of the description herein.

Reference will now be made to the various example embodiments. It will be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are explanatory of the disclosure and are not intended to be restrictive thereof.

Reference throughout this disclosure to “an aspect”, “another aspect” or similar language may refer, for example, to a particular feature, structure, or characteristic described in connection with the embodiment being included in at least one embodiment of the present disclosure. Thus, appearances of the phrase “in an embodiment”, “in another embodiment” and similar language throughout this disclosure may, but do not necessarily, all refer to the same embodiment.

The terms “comprises”, “comprising”, or any other variations thereof, are intended to cover a non-exclusive inclusion, such that a process or method that comprises a list of steps or operations does not include only those steps but may include other steps or operations not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The present disclosure discloses a method and system for switching a data session for an application in Fifth Generation Cellular Network (5G) by a User Equipment (UE) with dual SIM. In an example, the UE may be a laptop, a mobile phone, a PDA (Personal Digital Assistant), a smart phone, a multimedia device, a wearable device, etc. For example, the present disclosure provides for switching the data session of the application to a secondary Subscriber Identity Module (SIM) for continuing the data session in response to determining a User Equipment Route Selection Policy (URSP) rule present in the secondary SIM corresponding to the application.

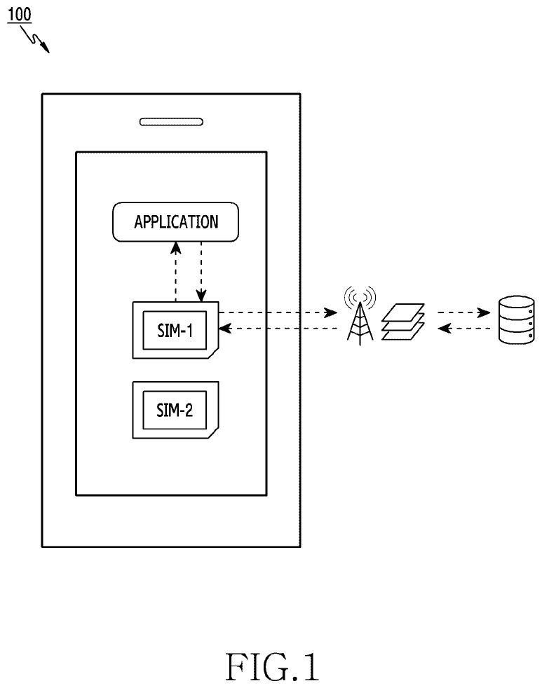

FIGS. 1 through 14, discussed below, and the various example embodiments used to describe the principles of the present disclosure in this disclosure are provided by way of illustration only and should not be construed in any way to limit the scope of the disclosure. Those skilled in the art will understand that the principles of the present disclosure may be implemented in any suitably arranged system or device

FIG. 1 is a diagram illustrating an application 100 using a primary SIM for a data session in a fifth-generation network, according to various embodiments.

As depicted, dual SIM may be installed in the UE. For instance, the UE may have a primary SIM and a secondary SIM. The primary SIM may be configured as a Default Data Subscription (DDS) providing the data session for the application running on the UE. In an embodiment of the present disclosure, the application may be using the data session through the primary SIM in 5G network to connect with an application server. In the example, an operator of the primary SIM may route traffic for the application, say, a video application through the URSP rule categorized as default in the primary SIM. However, the secondary SIM may have a subscription for video streaming related to the video application e.g., the secondary SIM has URSP rule corresponding to the application currently running on the UE. The existing techniques does not disclose any approach to switch the data session between dual SIM based on the presence of URSP rule for the current application running on the UE.

Accordingly, there is a need for a technique which may provide solution for switching the data session of the application between dual SIM based on the URSP corresponding to the application.

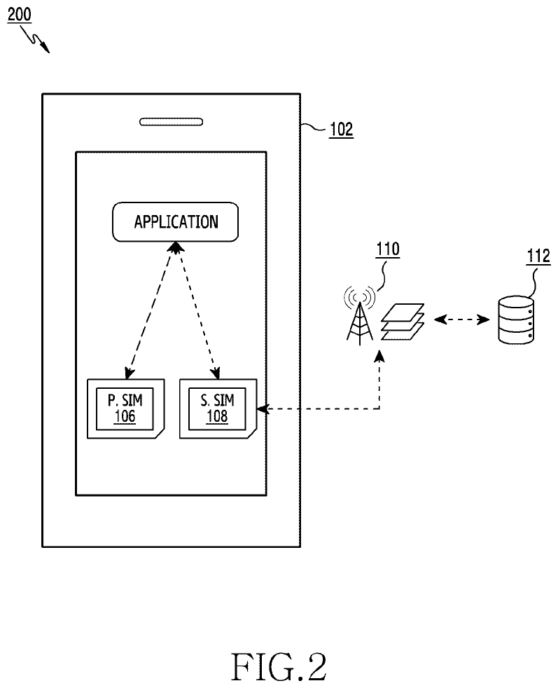

FIG. 2 is a block diagram 200 illustrating an example environment of implementation of the present disclosure, according to various embodiments.

In various embodiments, the present disclosure is implemented between the UE 102 and Fifth Generation Cellular Network (5G) 110. The UE 102 may include, but not limited to, a smartphone, a tablet, a smart watch. The UE 102 may include dual Subscriber Identity Module (SIM). For example, the UE 102 may include a primary SIM 106 and the secondary SIM 108. In an example, the primary SIM 106 may be configured as a Default Data Subscription (DDS) providing the data session for the application 104 running on the UE 102. The application 104 may be installed in the UE 102 and connects to a server 112 remotely present via 5G.

In various embodiments of the present disclosure, each of the primary SIM 106 and the secondary SIM 108 may include URSP rule defined by the 5G 110 (e.g., base station) to route data from the application 104 through specific Data Network Names (DNN), slice. In an example, the URSP rule are determined for the primary SIM 106 and the secondary SIM 108. If the URSP rule of the secondary SIM 108 includes entry for the application 104 which may be current running on the UE 102, then the UE 102 may be configured to switch the data session of the application from the primary SIM 106 to the secondary SIM 108. Such that, switching of the data session may be based on the UE 102 subscription for the application 104 on different SIM and may not be based on a network condition. Thus, the application 104 may switch the data session to the secondary SIM 108 for continuing the data session.

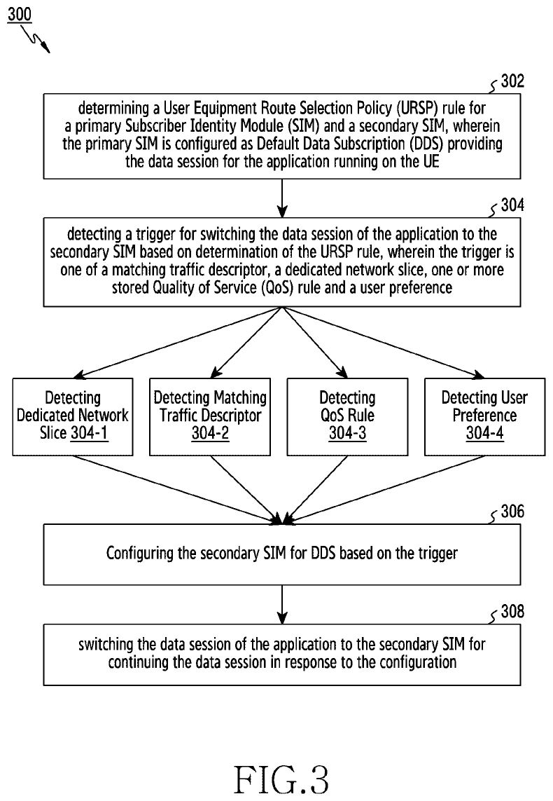

FIG. 3 is a flowchart illustrating an example method 300 for switching the data session for the application 104 in Fifth Generation Cellular Network (5G) by the User Equipment (UE) 102 with dual SIM, according to various embodiments. The method 300 may be a computer-implemented method executed, for example, by the UE 102. For the sake of brevity, constructional and operational features are explained in greater detail with reference to FIGS. 2, 11, and 12.

At 302, the method 300 may include determining the URSP rule for each of the SIM in the UE. For example, for the primary SIM 106 and the secondary SIM 108. In an example, the primary SIM 106 may be configured as a default SIM in the UE e.g., providing the data session for the application 104 installed in the UE 102. Thus, the primary SIM 106 may be the Default Data Subscription (DDS) providing the data session for the application 104 running on the UE 102. Each of the primary SIM 106 and the secondary SIM 108 may include the URSP rule for routing the data session of the application 104 in 5G. In the method 300, the UE 102 may be configured to evaluate combination of the URSP rule including the URSP rule of the primary SIM 106 and the URSP rule of the secondary SIM 108. The evaluation of the combination of the URSP rule may be performed to determine which of the primary SIM 106, the secondary SIM 108 may be used for continuing the data session of the application 104 running on the UE 102.

At 304, the method 300 may include detecting a trigger for switching the data session of the application 104 to the secondary SIM 108. The method 300 may include, based on determination of the URSP rule in dual sim e.g., the primary SIM 106 and the secondary SIM 108, the application 104 may switch the data session to the secondary SIM 108. In an example, the switching of the data session may be triggered by one of a:

a) Detecting a dedicated network slice 304-1; or
b) Detecting a matching traffic descriptor 304-2; or
c) Detecting one or more stored Quality of Service (QoS) rule 304-3; or
d) Detecting a user preference 304-4.

In an embodiment, the trigger may indicate presence of condition which may trigger the UE 102 to switch the data session for the application 104 currently running on the UE 102. Such that, the data session received by the application 104 through the secondary SIM 108 is enhanced in response to continuing the data session on the secondary SIM 108. Each of the triggering condition is explained in detail in the subsequent paragraphs.

At 306, the method 300 may include configuring the secondary SIM 108 to provide data session to the application 104. The method 300 may include the secondary SIM 108 may be configured as the DDS providing the data session for the application running on the UE based on the trigger.

At 308, the method 300 may include switching the data session of the application 104 to the secondary SIM 108 for continuing the data session in response to the configuration.

In an embodiment, the method 300 may include identifying whether the application 104 is one of a first type or a second type. In an example, the first type is indicative of the application 104 configured to establish the data session with a one of a dedicated slice, a dedicated Data Network Name (DNN), a Local Area Data Network (LADN), or a dedicated operator. The application 104 being the first type may indicate that the application 104 may be supported on any data connection provided by either the primary SIM 104 or the secondary SIM 106. In another example, the second type is indicative of the application 104 configured to establish the data session with one of a predefined type of slice, a predefined (e.g., specified) type of DNN, a predefined type of LADN, or a predefined type of operator. In the example, the application 104 may not be able to establish the data session in absence of the predefined type of slice, the predefined type of DNN, the predefined type of LADN, or a predefined type of operator.

The method 300 may include identifying based on the type of the application, one of the primary SIM 106 and the secondary SIM 108 configured for supporting the application 104 for establishing the data session. Further, the method 300 may include establishing the data session for the application 104 with identified one of the primary SIM 106 and the secondary SIM 108. In an instance, if the UE 102 may identify that the application 104 is of first type, then the UE 102 may identify whether the application 104 may be supported on the primary SIM 106 or the secondary SIM 108. In the instance, as the primary SIM 106 may be configured as the DDS, the UE 102 may continue the data session for the application 104 being the first type currently running on the UE 102 using the primary SIM 106. In another instance, if the UE 102 may identify that the application is of the second type, then the UE 102 may proceed to identify which of the primary SIM 106 or the secondary SIM 108 may have the matching traffic descriptor for the application 104. The UE 102 may switch the data session for the application 104 to the secondary SIM 108 upon identifying that the secondary SIM 108 includes the matching traffic descriptor for the application 104.

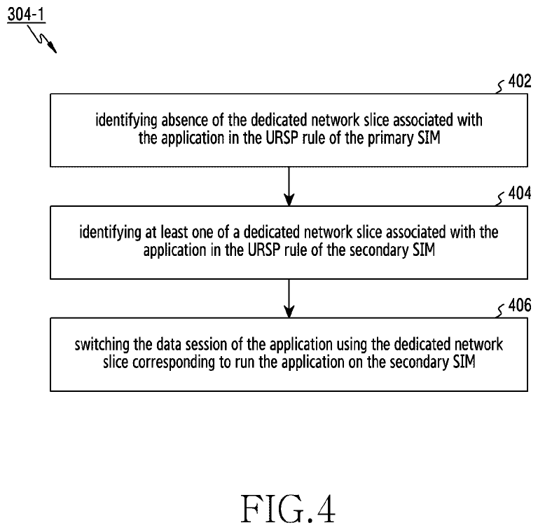

FIG. 4 is a flowchart 304-1 illustrating example operations for switching the data session of the application 104 using the dedicated network slice, according to various embodiments.

In continuation from operation 304 of the method 300, operation 304-1 may include detecting the trigger as presence of the dedicated network slice for switching the data session of the application in the secondary SIM 108.

At 402, operation 304-1 may include identifying absence of the dedicated network slice. The method 304-1 may include that the URSP rule of the primary SIM 106 may not include the dedicated network slice for the application 104. In an example, the application 104 may be a video playback application which may be require the dedicated network slice for successfully consuming the data session and establish connected with the server 112 in 5G. Thus, according to the method 304-1, the UE 102 may identify that the primary SIM 106 may not include the dedicated network slice in the URSP rules for establishing the data session of the video application with the server 112.

At 404, operation 304-1 may include identifying the dedicated network slice in the URSP rule of the secondary SIM 108. The dedicated network slice thus identified in the URSP rule of the secondary SIM 108 may be associated with the application 104. The application 104 may prefer establishing the data session with the dedicated network slice in the URSP rule of the secondary SIM 108 for better connectivity.

At 406, operation 304-1 may include switching the data session of the application 104 using the dedicated network slice corresponding to run the application 104 on the secondary SIM 108. Thus, the UE 102 may switch the data session of the application 104 currently running on the UE 102 to the secondary SIM 108 such that the application 104 may use the dedicated network slice present in the URSP rule of the secondary SIM 108.

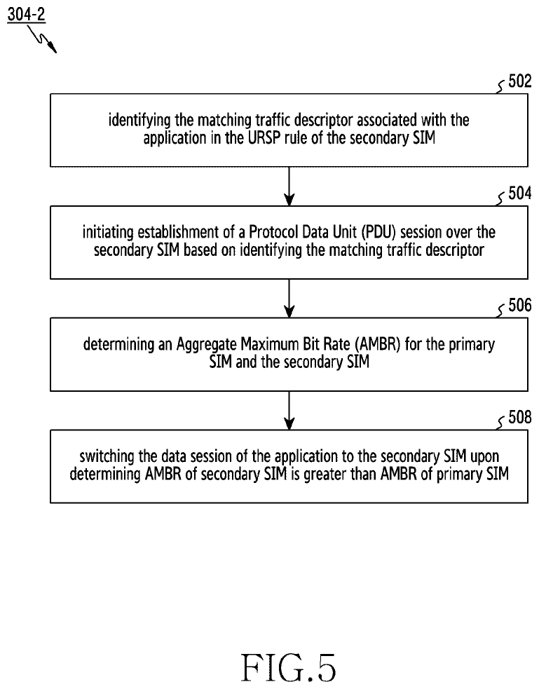

FIG. 5 is a flowchart 304-2 illustrating example operations for switching the data session of the application 104 to the secondary SIM 108 based on matching traffic descriptor, according to various embodiments.

In continuation from operation 304 of the method 300, operation 304-2 may include detecting the trigger as presence of the matching traffic descriptor for switching the data session of the application to the secondary SIM 108.

At 502, operation 304-2 may include identifying the matching traffic descriptor associated with the application 104 in the URSP rule of the primary SIM 106 and the secondary SIM 108. In an example, the application 104, say a video playback application may require specific traffic descriptor for establishing the data session with the server 112. According to the method 304-2, the UE 102 may identify presence of the matching traffic descriptor associated with the video playback application in the URSP rule of the primary SIM 106 and the secondary SIM 108. In the example, the UE 102 may identify that the URSP rule of the secondary SIM 108 may include the traffic descriptor matching the requirement of the video playback application.

In continuation at 504 operation 304-2 may include initiating establishment of a Protocol Data Unit (PDU) session over the secondary SIM 108 based on identifying the matching traffic descriptor.

At 506, operation 304-2 may include determining an Aggregate Maximum Bit Rate (AMBR) for the primary SIM 106 and the secondary SIM

At 508, operation 304-2 may include switching the data session of the application 104 to the secondary SIM 108. In the method 304-2 the AMBR of the secondary SIM 108 is greater than AMBR of primary SIM 106.

In an example, wherein the primary SIM 106 may be configured as the DDS, the UE 102 may be establishing the data session for the application 104 currently running on the UE 102 via the primary SIM 106. In the example, the primary SIM 106 may include the matching traffic descriptor for the application 104. Thus, the UE 102 may establish the PDU session based on the Route Selection Descriptor (RSD) in URSP rules of the primary SIM 106. Now, if the UE 102 receive the PDU session modification request it may change the AMBR to a lower value causing the application 104 to experience low data rate. Thus, the in accordance with the embodiment, the UE 102 may identify that the URSP rule of the secondary SIM 108 may include matching traffic descriptor associated with the application 104. In the example, the UE 102 may establish the PDU session based on the RSD provided in the URSP rules of the secondary SIM 108 upon identifying matching traffic descriptor. Further, the UE 102 may determine that the AMBR of the secondary SIM 108 is greater than the AMBR of the primary SIM 106. Thus, the UE 102 may be configured to switch the data session of the application 104 to the secondary SIM 108.

In an embodiment, wherein the primary SIM 106 may be configured as the DDS, the UE 102 may attempt to establish the data session for the application 104 currently running on the UE 102 via the primary SIM 106. In the example, the primary SIM 106 may not include the matching traffic descriptor for the application 104. Thus, while initiating establishment of the PDU session over the primary SIM 106 prior to identifying the matching traffic descriptor associated with the application in the URSP rule of the secondary SIM 108, the UE 102 may receive a rejection. In the example, the rejection is in response to initiating establishment of the PDU session over the primary SIM 106 based on identifying the matching traffic descriptor for the application 104. In the example, the UE 102 may proceed with identifying the dedicated network slice associated to the application 104 in the URSP rule of the secondary SIM 108. Thus, the UE 102 may be configured to switch the data session of the application 104 using the associated dedicated network slice to run the application data through secondary SIM 108.

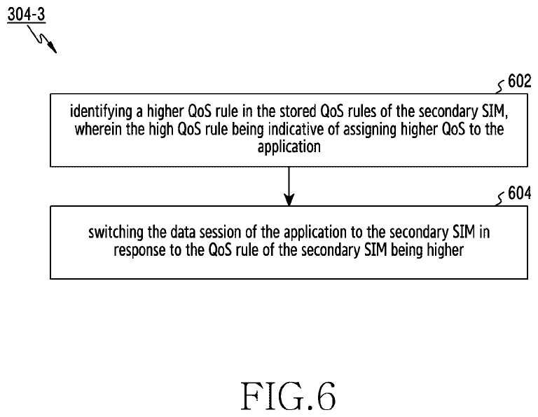

FIG. 6 is a flowchart 304-3 illustrating example operations for switching the data session of the application 104 to the secondary SIM 108 based on the stored Quality of Service (QoS) rule, according to various embodiments.

In continuation from operation 304 of the method 300, operation 304-3 may include detecting the trigger as presence of a higher QoS rule for switching the data session of the application to the secondary SIM 108.

At 602, operation 304-3 may include identifying the higher QoS rule in the secondary SIM 108. The method 304-3 may include each of the primary SIM 106 and the secondary SIM 108 receiving QoS rules upon receiving the URSP rules update. The QoS rules received are stored and referred for managing data traffic for the application 104. The higher QoS rule for the application 104 may indicate providing priorities to the application 104 for establishing the data session.

At 604, operation 304-3 may include switching the data session of the application 104 to the secondary SIM 108 in response to the QoS rule of the secondary SIM being higher.

In an embodiment, both the primary SIM 106 and the secondary SIM 108 may have matching traffic descriptors. Now, as the primary SIM 106 may be configured as the DDS, the UE 102 may be establishing the data session for the application 104 via PDU session established based on RSD provided in URSP rules of the primary SIM 106. Upon receiving an update in the URSP policy, the UE 102 may attempt to establish PDU session on both SIMs. The UE 102 may switch to the secondary SIM 108 if the URSP rules has better QoS rules stored for the application 104 currently running on the UE 102. In the example, the QoS rules stored for the primary SIM 106 and the secondary SIM 108 corresponding to the application 104 may be updated based on a time, a power-cycle.

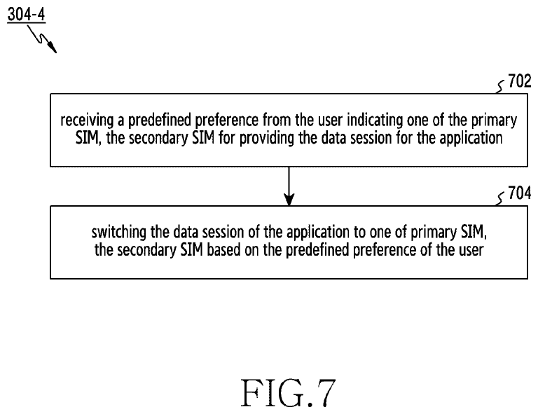

FIG. 7 is a flowchart 304-4 illustrating example operations for switching the data session of the application based on the predefined preference of the user, according to various embodiments.

In continuation from operation 304 of the method 300, operation 304-4 may include detecting the trigger as the predefined preference of the user for switching the data session of the application 104 to the secondary SIM 108.

At 702, operation 304-4 may include receiving the predefined preference from a user for establishing the data session for the application with either the primary SIM 106, or the secondary SIM 108.

At 702, operation 304-4 may include switching the data session of the application 104 to one of the primary SIM 106, or the secondary SIM 108 based on the predefined preference as submitted by the user.

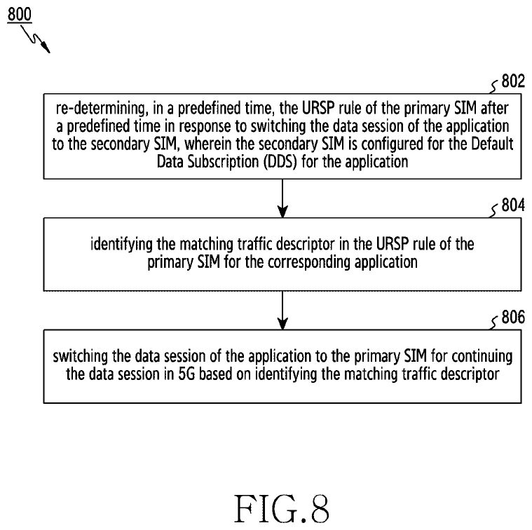

FIG. 8 is a flowchart illustrating an example method 800 for switching the data session of the application to the primary SIM based on the matching traffic descriptor, according to various embodiments.

At 802, the method 800 may include re-determining the URSP rule of the primary SIM 106 after a predefined time to determine if the URSP rule may be updated with the matching traffic descriptor for the application 104 currently running on the UE 102. In an embodiment, the data session of the application 104 may be switched to the secondary SIM 108 in response to identifying absence of the matching traffic descriptor in the primary SIM 106. Thus, in an embodiment, after the predefined time the URSP rules of the primary SIM 106 are re-determined for verifying if the matching traffic descriptor for the application 104 is updated in the URSP rules of the primary SIM 106.

At 804, the method 800 may include identifying the matching traffic descriptor in the URSP rule of the primary SIM 106 for the corresponding application.

At 806, the method 800 may include switching the data session of the application 104 to the primary SIM 106 for continuing the data session in 5G based on identifying the matching traffic descriptor. In an example, primary SIM 106 may receive an update in the URSP rules. The update may include receiving the matching traffic descriptor corresponding to the application 104. Thus, after the predefined time the UE 102 may re-determine the URSP rule of the primary SIM 106 to identify if the updated URSP rules may include the matching traffic descriptor corresponding to the application 104. In the example, the UE 102 may switch the data session of the application 104 from the secondary SIM 108 to the primary SIM 106 for continuing the data session in response to identifying the matching traffic descriptor in the URSP rule of the primary SIM 106.

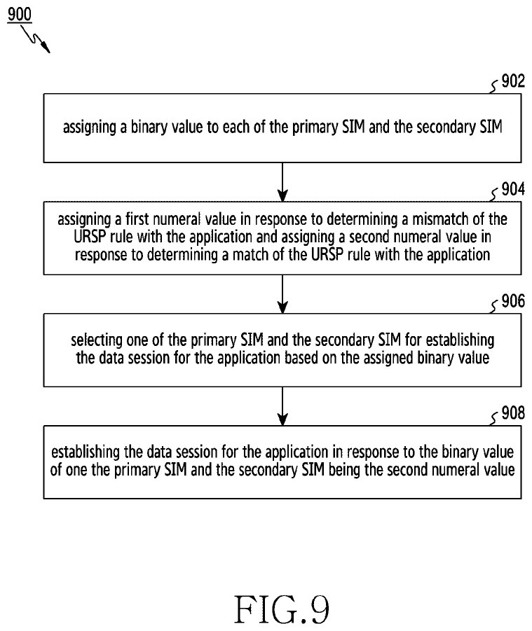

FIG. 9 is a flowchart illustrating an example method 900 for assigning a binary value to each of the primary SIM 106 and the secondary SIM 108 for switching the data session of the application, according to various embodiments.

At 902, the method 900 may include assigning the binary value to each of the primary SIM 106 and the secondary SIM 108. In the method 900, the binary value may be assigned to determine a preference for establishing the data session of the application 104 to the primary SIM 106 and the secondary SIM 108.

At 904, the method 900 may include assigning a first numeral value and assigning a second numeral value to each of the primary SIM 106 and the secondary SIM 108. The first numeral value is assigned in response to determining a mismatch of the URSP rule with the application. The second numeral value is assigned in response to determining a match of the URSP rule with the application. In an example table below, to select either the primary SIM 106 or the secondary SIM 108 the method 900 may assign a binary value e.g., 1 or 0 in below table of various embodiments of the present disclosure.

TABLE 1

| SELECTION OF SIM BASED ON THE FOLLOWING | BINARY |
|---|---|
| PROPERTY | VALUE |
| If the URSP rule is matched for the application 104, the UE | 1 |
| 102 may establish PDU session with the RSD | |
| If no RSD for the URSP rule matches for the application | 0 |
| 104, UE rejects the PDU session establishment | |

In an embodiment, the method 900 may include training the assignment of the binary value for both the primary SIM 106 and the secondary SIM 108 for a predefined time duration and the store the assigned binary value in the UE 102. In the example table below, the binary value may be assigned for number of iterations e.g., predefined time duration:

TABLE 2

| PRIMARY SIM 106 | SECONDARY SIM 108 |
|---|---|
| 1 | 1 |
| 0 | 1 |
| 1 | 0 |
| — | — |
| 0 | 1 |

At 906, the method 900 may include selecting either the primary SIM 106 or the secondary SIM 108 for establishing the data session for the application 104 based on the assigned binary value. Such that a learning mechanism is defined in the UE 102 for predicting which SIM is to be selected for establishing the data session for the application 104 based on training. In an embodiment, a multi-armed bandit technique may be used for prediction. In an embodiment, the multi-armed bandit technique may include:

Operation (i) Determining the assigned binary value for the primary SIM 106 or the secondary SIM 108 at the predefined time duration ‘t’. Also, determine the assigned binary value for previous information at time duration say ‘t−1’. The following operations are considered as state ‘S’ which may measure traffic descriptor for time. For instance, Sₜ and Sₜ₋₁. The State ‘S’ may be either 1 or 0.

Operation (ii) Based on the state, the UE 102 may decide an action ‘a’ also called as action-value function at time ‘t’ to select either the primary SIM 106 or the secondary SIM 108. It may be represented by Q(a) and defines average reward for each action at the time ‘t’.

Q(a)=E[r|a]

where the predicted SIM selection at time ‘t’ is the reward for the states {Sₜ, Sₜ₋₁, Sₜ₋₂, . . . Sₜ₋ₖ} before any new URSP rule is defined matching the application to establish the PDU session.

Operation (iii) The selection of SIM considers an action value to predict either the primary SIM 106 or the secondary SIM 108 as action may be stored at UE 102 at each time step by the function Qₜ(a) and the action chosen at each time-step given as:

$${Q}_{t} ( a ) = \frac{{\sum }_{i = 1}^{t} {1}_{( {a}_{t} = a )} \cdot {R}_{i}}{{\sum }_{i = 1}^{t} {1}_{( {a}_{t} = a )}} {argmax}_{a} {Q}_{t} ( a )$$

Operation (iv) At each time ‘t’, the Q-value for each action is performed to compute the selection of SIM as reward for Qₜ:

$${Q}_{t} ( a ) = \frac{{Q}_{t - 1} ( a ) {N}_{t} ( {a}_{t} ) + {R}_{t} \cdot {1}_{( {a}_{t} = a )}}{{N}_{t} ( {a}_{t} )}$$

$${Q}_{t} ( a ) = {Q}_{t - 1} ( a ) + \frac{1}{{N}_{t} ( {a}_{t} )} ( {R}_{t} - {Q}_{t - 1} ( a ) )$$

Operation (v) The above expression is used to predict the selection of either the primary SIM 106 or the secondary SIM 108 at current state Sₜ based on the actions taken for states {Sₜ, Sₜ₋₁, Sₜ₋₂, . . . Sₜ₋ₖ}.

Thus, simulations are conducted to assign the binary value e.g., 1 or 0. In the example, up to 1000 iterations may be performed to predict selection of the primary SIM 106 or the secondary SIM 108 based on above steps (i) to (v) using probability distribution.

In continuation with the previous operation, at 908, the method 900 may include establishing the data session for the application 104 in response to the assigned binary value. Based on the example explained above, the second value e.g., 1 may indicate establishment of the data session. Thus, the data session may be established with either the primary SIM 106 or the secondary SIM 108 with the assigned binary value of 1.

In an embodiment, the method 900 may include defining a rule-based mode and a learning-based mode for switching the data session of the application 104 to either one of the primary SIM 106 or the secondary SIM 108 based on determining the URSP rule.

In an embodiment, the rule-based mode may refer, for example, to assigning the binary value to either of the primary SIM 106 or the secondary SIM 108. Such that, in the example, a selected value that is equivalent to the binary value ‘1’ is assigned to the primary SIM 106 or the secondary SIM if the URSP rule of SIM are associated with the application 104 currently running on the UE 102. The selected value may be assigned upon determining presence of the URSP rule for the application 104 and the UE 102 establishing the PDU session. In other case, an unselected value that is equivalent to the binary value ‘0’ is assigned to the primary SIM 106 or the secondary SIM if the URSP rule of SIM are not associated with the application 104 currently running on the UE 102. The unselected value may be assigned upon determining absence of the URSP rule for the application 104 and failure of the UE 102 to establish the PDU session. Further in, as explained above, the method 90 may include iterations for training the rule-based mode to select switching of the data session of the application 104. The data session may be established for the application 104 running on the UE 102 to either one of the primary SIM 106 or the secondary SIM 108 based on the assigned one of the selected value or the unselected value.

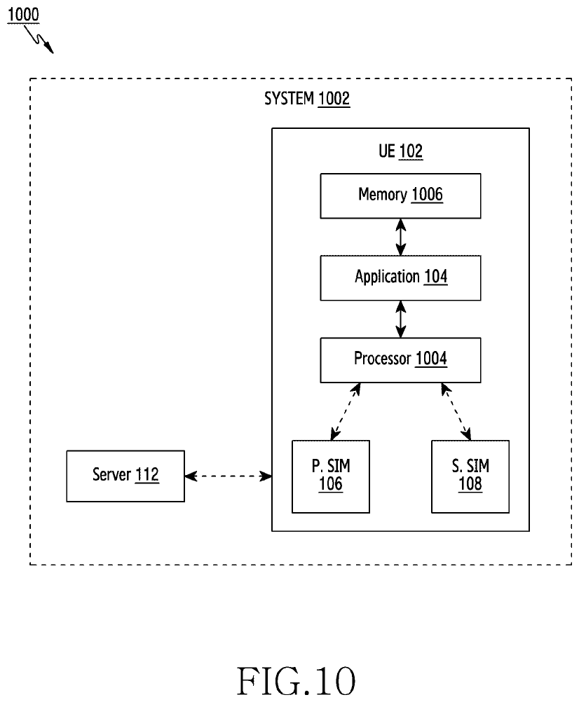

FIG. 10 is a block diagram illustrating an example system architecture 1000 according to various embodiments.

FIG. 10 illustrates an example system architecture 1000 to provide tools and implementation environment described herein for a technical realization of a system 702 for the data session switching for the application 104 in 5G 110 by the UE 102 with dual SIM. FIG. 10 is a non-limiting example, and it will be appreciated that many other architectures may be implemented to facilitate the functionality described herein. The architecture 1000 may be executing on hardware such as the UE 102 and the server 112 in 5G 110 of FIG. 10 that includes, among other things, processors, memory, and various application-specific hardware components.

The architecture 1000 may include an operating-system, libraries, frameworks or middleware. The operating system may manage hardware resources and provide common services. The operating system may include, for example, a kernel, services, and drivers defining a hardware interface layer. The drivers may be responsible for controlling or interfacing with the underlying hardware. For instance, the drivers may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

A hardware interface layer includes libraries which may include system libraries such as file system (e.g., C standard library) that may provide functions such as memory allocation functions, string manipulation functions, mathematic functions, and the like. In addition, the libraries may include API libraries such as audio-visual media libraries (e.g., multimedia data libraries to support presentation and manipulation of various media format such as MPEG4, H.264, MP3, AAC, AMR, JPG, PNG), database libraries (e.g., SQLite that may provide various relational database functions), web libraries (e.g., WebKit that may provide web browsing functionality), and the like.

A middleware may provide a higher-level common infrastructure such as various graphic user interface (GUI) functions, high-level resource management, high-level location services, and so forth. The middleware may provide a broad spectrum of other APIs that may be utilized by the applications or other software components/modules, some of which may be specific to a particular operating system or platform.

The term “module” used in this disclosure may refer to a certain unit that includes one or more of hardware, software and firmware or any combination thereof. The module may be interchangeably used with unit, logic, logical block, component, or circuit, for example. The module may be the minimum unit, or part thereof, which performs one or more particular functions. The module may be formed mechanically or electronically. For example, the module disclosed herein may include at least one of ASIC (Application-Specific Integrated Circuit) chip, FPGAs (Field-Programmable Gate Arrays), and programmable-logic device, which have been known or are to be developed.

Further, the architecture 1000 includes the system 1002 implemented in the UE 102. The UE 102 may include the application 104. The UE 102 may include the processor (e.g., including processing circuitry) 1004 in communication with the application 104 and operatively coupled with a memory 1006. The processor 1004 is configured to switch the data session of the application currently running on the UE 102 to either the primary SIM 106 or the secondary SIM 108.

In an embodiment, the system 1002 for switching the data session of the application 104 currently running on the UE 102 to either the primary SIM 106 or the secondary SIM 108 is disclosed, according to an embodiment of the present disclosure. For the sake of brevity, the system 1002 switching the data session of the application 104 is hereinafter interchangeably referred to as the system 1002.

In an embodiment, the processor 1004 is in communication with the application 104, the primary SIM 106 and the secondary SIM 108. The processor 1004 is configured to determine the URSP rule for the primary SIM 106 and the secondary SIM 108. The primary SIM 106 is configured as Default Data Subscription (DDS) providing the data session for the application 104 running on the UE 102. The processor 1004 is configured to detect a trigger for switching the data session of the application 104 to the secondary SIM 108 based on determination of the URSP rule. The trigger is one of a matching traffic descriptor the dedicated network slice, one or more stored Quality of Service (QoS) rule or the user preference. The processor 1004 is configured to configure, the secondary SIM 108 for the DDS based on the trigger and switch the data session of the application 104 to the secondary SIM 108 for continuing the data session in response to the configuration.

In an embodiment, when the trigger is the dedicated network slice, the processor 1004 is configured to identify absence of the dedicated network slice associated with the application 104 in the URSP rule of the primary SIM 106. The processor 1004 is configured to identify a dedicated network slice associated with the application 104 in the URSP rule of the secondary SIM 108 and switch the data session of the application 104 using the dedicated network slice corresponding to run the application 104 on the secondary SIM 108.

In an embodiment, when the trigger is the matching traffic descriptor, the processor 1004 is configured to identify the matching traffic descriptor associated with the application 104 in the URSP rule of the secondary SIM 108. The processor 1004 is configured to initiate establishment of the PDU session over the secondary SIM 108 based on identifying the matching traffic descriptor. The processor 1004 is configured to determine AMBR for the primary SIM 106 and the secondary SIM 108 and switch the data session of the application 104 to the secondary SIM 108 upon determining AMBR of secondary SIM 108 is greater than AMBR of primary SIM 106.

In an embodiment, the processor 1004 is configured to initiate establishment of the PDU session over the primary SIM 106 prior to identifying the matching traffic descriptor associated with the application 104 in the URSP rule of the secondary SIM 108. The processor 1004 is configured to receive a rejection in response to initiating establishment of the PDU session over the primary SIM 106 based on identifying the matching traffic descriptor for the application 104. The processor 1004 is configured to identify the dedicated network slice associated to the application 104 in the URSP rule of the secondary SIM 108 and switch the data session of the application 104 using the associated dedicated network slice to run the application 104 data through secondary SIM 108.

In an embodiment, when the trigger is the stored one QoS rule, the processor 1004 is configured to identify a higher QoS rule in the stored QoS rules of the secondary SIM 108. The high QoS rule being indicative of assigning higher QoS to the application and switch the data session of the application 104 to the secondary SIM 108 in response to the QoS rule of the secondary SIM 108 being higher.

In an embodiment, the processor 1004 is configured to re-determine, in a predefined time, the URSP rule of the primary SIM 106 after a predefined time in response to switching the data session of the application 104 to the secondary SIM 108. The secondary SIM 108 is configured for a Default Data Subscription (DDS) for the application 104. The processor 1004 is configured to identify the matching traffic descriptor in the URSP rule of the primary SIM 106 for the corresponding application 104 and switch the data session of the application 104 to the primary SIM 106 for continuing the data session in 5G based on identifying the matching traffic descriptor.

In an embodiment, the processor 1004 is configured to identify whether the application is one of a first type or a second type, wherein the first type is indicative of the application configured to establish the data session with one of a dedicated slice, a dedicated Data Network Name (DNN), an Local Area Data Network (LADN), and a dedicated operator, and wherein the second type is indicative of the application configured to establish the data session only with one of a predefined type of slice, a predefined type of DNN, a predefined type of LADN, and a predefined type of operator, wherein the application is supported through anyone one of a data connection type. The processor 1004 is configured to identify one of the primary SIM 106 and the secondary SIM 108 configured for supporting the application 104 for establishing the data session based on the type of the application and establish the data session for the application 104 with identified one of the primary SIM 106 and the secondary SIM 108.

In an embodiment, the processor 1004 is configured to assign the binary value to each of the primary SIM 106 and the secondary SIM 108. The processor 1004 is configured to assign the binary value includes assigning a first numeral value in response to determining a mismatch of the URSP rule with the application 104 and assigning a second numeral value in response to determining a match of the URSP rule with the application 104. Further, select one of the primary SIM 106 and the secondary SIM 108 for establishing the data session for the application 108 based on the assigned binary value. The processor 1004 may then establish the data session for the application 104 in response to the binary value of one the primary SIM 106 and the secondary SIM 108 being the second numeral value.

In an embodiment, the processor 1004 is configured to define one of a rule-based mode, a learning-based mode to switch the data session of the application 104 to either one of the primary SIM 106 or the secondary SIM 108 based on determining the URSP rule.

The rule-based mode may include the processor 1004 assigning one of a selected value or an unselected value to either one of the primary SIM 106 or the secondary SIM 108 upon matching of the URSP rule. The selected value being assigned upon determining presence of the URSP rule for the application 104 and the UE 102 establishing the PDU session. The unselected value being assigned upon determining absence of the URSP rule for the application and failure of the UE to establish the PDU session and train the rule-based mode to select switching of the data session of the application to either one of the primary SIM or the secondary SIM based on the assigned one of the selected value or the unselected value.

The learning-based mode may include the processor 1004 determining a state of the primary SIM 106 and the secondary SIM 108. The state indicative of measuring a traffic characteristics for a predefined time. The processor 1004 is configured to determine a probability distribution between the primary SIM 106 and the secondary SIM 108, based on the state and switch of the data session of the application 104 to either one of the primary SIM 106 or the secondary SIM 108 based on the probability distribution.

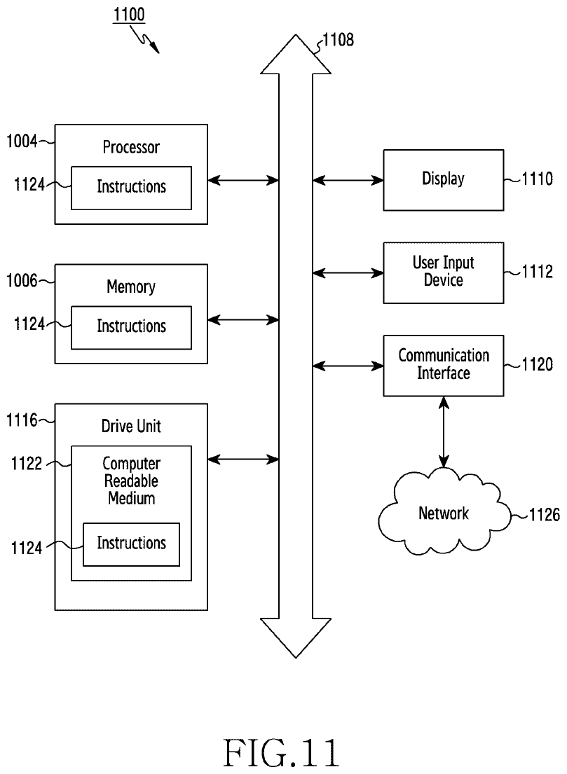

FIG. 11 is a diagram illustrating an example system architecture of the system 1002 in the form of a computer system 1100 according to various embodiments. The computer system 1100 can include a set of instructions that can be executed to cause the computer system 1100 to perform any one or more of the methods disclosed. The computer system 1100 may operate as a standalone device or may be connected, e.g., using a network, to other computer systems or peripheral devices.

In a networked deployment, the computer system 1100 may operate in the capacity of a server or as a client user computer in a server-client user network environment, or as a peer computer system in a peer-to-peer (or distributed) network environment. The computer system 1100 can also be implemented as or incorporated across various devices, such as a personal computer (PC), a tablet PC, a personal digital assistant (PDA), a mobile device, a palmtop computer, a laptop computer, a desktop computer, a communications device, a wireless telephone, a land-line telephone, a web appliance, a network router, switch or bridge, or any other machine capable of executing a set of instructions (sequential or otherwise) that specify actions to be taken by that machine. Further, while a single computer system 1100 is illustrated, the term “system” shall also be taken to include any collection of systems or sub-systems that individually or jointly execute a set, or multiple sets, of instructions to perform one or more computer functions.

The computer system 1100 may include the processor (e.g., including processing circuitry) 1004 e.g., a central processing unit (CPU), a graphics processing unit (GPU), or both. The processor 1004 may be a component in a variety of systems. For example, the processor 1004 may be part of a standard personal computer or a workstation. The processor 1004 may be one or more general processors, digital signal processors, application-specific integrated circuits, field-programmable gate arrays, servers, networks, digital circuits, analog circuits, combinations thereof, or other now known or later developed devices for analyzing and processing data. The processor 1004 may implement a software program, such as code generated manually (e.g., programmed).

The computer system 1100 may include a memory 1006, such as a memory 1006 that can communicate via a bus 1108. The memory 1006 may include but is not limited to computer-readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one example, memory 1006 includes a cache or random-access memory for the processor 1004. In various examples, the memory 1004 is separate from the processor 1004, such as a cache memory of a processor, the system memory, or other memory. The memory 1006 may be an external storage device or database for storing data. The memory 1006 is operable to store instructions executable by the processor 1004. The functions, acts or tasks illustrated in the figures or described may be performed by the programmed processor 1004 for executing the instructions stored in the memory 1006. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing and the like.

As shown, the computer system 1100 may or may not further include a display unit (e.g., including a display) 1110, such as a liquid crystal display (LCD), an organic light-emitting diode (OLED), a flat panel display, a solid-state display, a cathode ray tube (CRT), a projector, a printer or other now known or later developed display device for outputting determined information. The display 1110 may act as an interface for the user to see the functioning of the processor 1004, or specifically as an interface with the software stored in the memory 1006 or the drive unit 1116.

Additionally, the computer system 1100 may include an input device (e.g., including input circuitry) 1112, for example, a user input device configured to allow the user to interact with any of the components of system 1100. The computer system 1100 may also include a disk or optical drive unit (e.g., including various circuitry) 1116. The disk drive unit 1116 may include a computer-readable medium 1122 in which one or more sets of instructions 1124, e.g., software, can be embedded. Further, the instructions 1124 may embody one or more of the methods or logic as described. In an example, the instructions 1124 may reside completely, or at least partially, within the memory 1006 or within the processor 1004 during execution by the computer system 1100.

The present disclosure discloses a computer-readable medium that includes instructions 1124 or receives and executes instructions 1124 responsive to a propagated signal so that a device connected to a network 1126 can communicate voice, video, audio, images, or any other data over the network 1126. Further, the instructions 1124 may be transmitted or received over the network 1126 via a communication port or interface 1120 or using a bus 1108. The communication port or interface 1120 may be a part of the processor 1004 or maybe a separate component. The communication port 1120 may be created in software or maybe a physical connection in hardware. The communication port 1120 may be configured to connect with a network 1126, external media, the display 1110, or any other components in system 1100, or combinations thereof. The connection with the network 1126 may be a physical connection, such as a wired Ethernet connection or may be established wirelessly as discussed later. Likewise, the additional connections with other components of the system 1100 may be physical or may be established wirelessly. The network 1126 may alternatively be directly connected to the bus 1108.

The network 1126 may include wired networks, wireless networks, Ethernet AVB networks, or combinations thereof. The wireless network may be a cellular telephone network, an 802.11, 802.16, 802.20, 802.1Q or WiMax network. Further, the network 826 may be a public network, such as the Internet, a private network, such as an intranet, or combinations thereof, and may utilize a variety of networking protocols now available or later developed including, but not limited to TCP/IP based networking protocols. The system is not limited to operation with any particular standards and protocols. For example, standards for Internet and other packet-switched network transmissions (e.g., TCP/IP, UDP/IP, HTML, and HTTP) may be used.

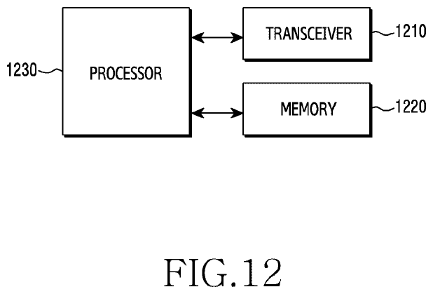

FIG. 12 is a block diagram illustrating an example structure of a UE according to various embodiments. Furthermore, the UE may correspond to UE 102 of FIG. 2.

As shown in FIG. 12, the UE according to an embodiment may include a transceiver (e.g., including transmitting/receiving circuitry) 1210, a memory 1220, and a processor (e.g., including processing circuitry) 1230. The transceiver 1210, the memory 1220, and the processor 1230 of the UE may operate according to a communication method of the UE described above. However, the components of the UE are not limited thereto. For example, the UE may include more or fewer components than those described above. In addition, the processor 1230, the transceiver 1210, and the memory 1220 may be implemented as a single chip. Also, the processor 1230 may include at least one processor.

The transceiver 1210 may collectively refer, for example, to a UE receiver and a UE transmitter, and may transmit/receive a signal to/from a base station or a network entity. The signal transmitted or received to or from the base station or a network entity may include control information and data. The transceiver 1210 may include a RF transmitter for up-converting and amplifying a frequency of a transmitted signal, and a RF receiver for amplifying low-noise and down-converting a frequency of a received signal. However, this is only an example of the transceiver 1210 and components of the transceiver 1210 are not limited to the RF transmitter and the RF receiver.

The transceiver 1210 may receive and output, to the processor 1230, a signal through a wireless channel, and transmit a signal output from the processor 1230 through the wireless channel.

The memory 1220 may store a program and data required for operations of the UE. The memory 1220 may store control information or data included in a signal obtained by the UE. The memory 1220 may be a storage medium, such as read-only memory (ROM), random access memory (RAM), a hard disk, a CD-ROM, and a DVD, or a combination of storage media.

The processor 1230 may include various processing circuitry and control a series of processes such that the UE operates as described above. For example, the transceiver 1210 may receive a data signal including a control signal transmitted by the base station or the network entity, and the processor 1230 may determine a result of receiving the control signal and the data signal transmitted by the base station or the network entity.

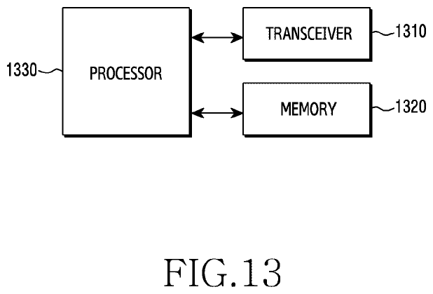

FIG. 13 is a block diagram illustrating an example structure of a base station according to various embodiments. Furthermore, the base station may correspond to base station 110 of FIG. 2.

As shown in FIG. 13, the base station according to an embodiment may include a transceiver (e.g., including transmit/receive circuitry) 1310, a memory 1320, and a processor (e.g., including processing circuitry) 1330. The transceiver 1310, the memory 1320, and the processor 1330 of the base station may operate according to a communication method of the base station described above. However, the components of the base station are not limited thereto. For example, the base station may include more or fewer components than those described above. In addition, the processor 1330, the transceiver 1310, and the memory 1320 may be implemented as a single chip. Also, the processor 1330 may include at least one processor.

The transceiver 1310 may collectively refer, for example, to a base station receiver and a base station transmitter, and may transmit/receive a signal to/from a terminal or a network entity. The signal transmitted or received to or from the terminal or a network entity may include control information and data. The transceiver 1310 may include a RF transmitter for up-converting and amplifying a frequency of a transmitted signal, and a RF receiver for amplifying low-noise and down-converting a frequency of a received signal. However, this is only an example of the transceiver 1310 and components of the transceiver 1310 are not limited to the RF transmitter and the RF receiver.

The transceiver 1310 may receive and output, to the processor 1330, a signal through a wireless channel, and transmit a signal output from the processor 1330 through the wireless channel.

The memory 1320 may store a program and data required for operations of the base station. The memory 1320 may store control information or data included in a signal obtained by the base station. The memory 1320 may be a storage medium, such as read-only memory (ROM), random access memory (RAM), a hard disk, a CD-ROM, and a DVD, or a combination of storage media.

The processor 1330 may include various processing circuitry and control a series of processes such that the base station operates as described above. For example, the transceiver 1310 may receive a data signal including a control signal transmitted by the terminal, and the processor 1330 may determine a result of receiving the control signal and the data signal transmitted by the terminal.

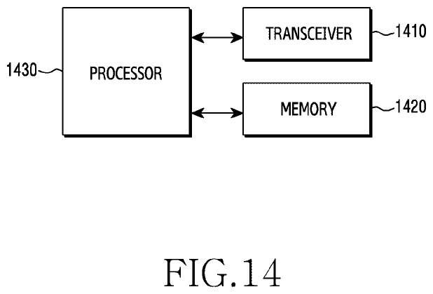

FIG. 14 is a block diagram illustrating an example structure of a network entity according to various embodiments. Furthermore, the network entity may correspond to server 112 of FIG. 2.

As shown in FIG. 14, the network entity of the present disclosure may include a transceiver (e.g., including transmit/receive circuitry) 1410, a memory 1420, and a processor (e.g., including processing circuitry) 1430. The transceiver 1410, the memory 1420, and the processor 1430 of the network entity may operate according to a communication method of the network entity described above. However, the components of the terminal are not limited thereto. For example, the network entity may include more or fewer components than those described above. In addition, the processor 1430, the transceiver 1410, and the memory 1420 may be implemented as a single chip. Also, the processor 1430 may include at least one processor.

The transceiver 1410 may collectively refer, for example, to a network entity receiver and a network entity transmitter, and may transmit/receive a signal to/from a base station or a UE. The signal transmitted or received to or from the base station or the UE may include control information and data. In this regard, the transceiver 1410 may include a RF transmitter for up-converting and amplifying a frequency of a transmitted signal, and a RF receiver for amplifying low-noise and down-converting a frequency of a received signal. However, this is only an example of the transceiver 1410 and components of the transceiver 1410 are not limited to the RF transmitter and the RF receiver.

The transceiver 1410 may receive and output, to the processor 1430, a signal through a wireless channel, and transmit a signal output from the processor 1430 through the wireless channel.

The memory 1420 may store a program and data required for operations of the network entity. The memory 1420 may store control information or data included in a signal obtained by the network entity. The memory 1420 may be a storage medium, such as ROM, RAM, a hard disk, a CD-ROM, and a DVD, or a combination of storage media.

The processor 1430 may include various processing circuitry and control a series of processes such that the network entity operates as described above. For example, the transceiver 1410 may receive a data signal including a control signal, and the processor 1430 may determine a result of receiving the data signal.

While specific language has been used to describe the disclosure, any limitations arising on account of the same are not intended. As would be apparent to on skilled in the art, various working modifications may be made to the method in order to implement the disclosure.

The drawings and the forgoing description give examples of various embodiments. Those skilled in the art will appreciate that one or more of the described elements may well be combined into a single functional element. Certain elements may be split into multiple functional elements. Elements from one embodiment may be added to another embodiment. For example, orders of processes described herein may be changed and are not limited to the manner described herein.

Moreover, the actions of any flowchart need not be implemented in the order shown; nor do all of the acts necessarily need to be performed. Those acts that are not dependent on other acts may be performed in parallel with the other acts. The scope of the various embodiments is by no means limited by these specific examples. Numerous variations, whether explicitly given in the disclosure or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A method for switching a data session for an application in a user equipment (UE) with a dual subscriber identity module (SIM) the method comprising:
determining a User Equipment Route Selection Policy (URSP) rule for a primary SIM and a secondary SIM, wherein the primary SIM is configured as a Default Data Subscription (DDS) providing a data session for the application running on the UE;
detecting a trigger for switching the data session of the application to the secondary SIM based on determination of the URSP rule, wherein the trigger includes one of a matching traffic descriptor, a dedicated network slice, one or more stored Quality of Service (QoS) rule and a user preference;
configuring the secondary SIM for the DDS based on the trigger; and
switching the data session of the application to the secondary SIM for continuing the data session in response to the configuration.

2. The method as claimed in claim 1, wherein when the trigger includes the dedicated network slice, the method further comprising:
identifying absence of the dedicated network slice associated with the application in the URSP rule of the primary SIM;
identifying at least one of a dedicated network slice associated with the application in the URSP rule of the secondary SIM; and
switching the data session of the application using the dedicated network slice corresponding to run the application on the secondary SIM.

3. The method as claimed in claim 1, wherein when the trigger includes the matching traffic descriptor, the method further comprising:
identifying the matching traffic descriptor associated with the application in the URSP rule of the secondary SIM;
initiating establishment of a Protocol Data Unit (PDU) session over the secondary SIM based on identifying the matching traffic descriptor;
determining an Aggregate Maximum Bit Rate (AMBR) for the primary SIM and the secondary SIM; and
switching the data session of the application to the secondary SIM based on determining AMBR of secondary SIM is greater than AMBR of primary SIM.

4. The method as claimed in claim 3 further comprising:
initiating establishment of the PDU session over the primary SIM prior to identifying the matching traffic descriptor associated with the application in the URSP rule of the secondary SIM;
receiving a rejection in response to initiating establishment of the PDU session over the primary SIM based on identifying the matching traffic descriptor for the application;
identifying at least one of the dedicated network slice associated to the application in the URSP rule of the secondary SIM; and
switching the data session of the application using the associated dedicated network slice to run the application data through secondary SIM.

5. The method as claimed in claim 1, wherein when the trigger includes at least one QoS rule, the method further comprising:
identifying a higher QoS rule in the stored QoS rules of the secondary SIM, wherein the higher QoS rule is indicative of assigning higher QoS to the application; and
switching the data session of the application to the secondary SIM in response to the QoS rule of the secondary SIM being higher.

6. The method as claimed in claim 1, wherein when the trigger includes the user preference, the method further comprising:
receiving a specified preference indicating one of the primary SIM, the secondary SIM for providing the data session for the application; switching the data session of the application to one of primary SIM and the secondary SIM based on the specified preference.

7. The method as claimed in claim 1 further comprising:
re-determining, in a specified time, the URSP rule of the primary SIM after a specified time in response to switching the data session of the application to the secondary SIM, wherein the secondary SIM is configured for the Default Data Subscription (DDS) for the application;
identifying the matching traffic descriptor in the URSP rule of the primary SIM for a corresponding application; and
switching the data session of the application to the primary SIM for continuing the data session based on identifying the matching traffic descriptor.

8. The method as claimed in claim 1, further comprising:
establishing the data session for the application by the UE prior to determining the URSP rule for the primary SIM and the secondary SIM, the method further comprising:
identifying whether the application is one of a first type or a second type, wherein the first type is indicative of the application configured to establish the data session with one of a dedicated slice, a dedicated Data Network Name (DNN), an Local Area Data Network (LADN), and a dedicated operator, and wherein the second type is indicative of the application configured to establish the data session with one of a specified type of slice, a predefined type of DNN, a specified type of LADN, and a specified type of operator, wherein the application is supported through any one of a data connection type;
identifying one of the primary SIM and the secondary SIM configured for supporting the application for establishing the data session based on the type of the application; and
establishing the data session for the application with the identified one of the primary SIM and the secondary SIM.

9. The method as claimed in claim 1, further comprising:
assigning a binary value to each of the primary SIM and the secondary SIM, wherein assigning the binary value comprises
assigning a first numeral value in response to determining a mismatch of the URSP rule with the application and assigning a second numeral value in response to determining a match of the URSP rule with the application; and
selecting one of the primary SIM and the secondary SIM for establishing the data session for the application based on the assigned binary value.

10. The method as claimed in claim 9, further comprising:
establishing the data session for the application in response to the binary value of one the primary SIM and the secondary SIM being the second numeral value.

11. The method as claimed in claim 1, comprising:
defining one of a rule-based mode, a learning-based mode to switch the data session of the application to either one of the primary SIM or the secondary SIM based on determining the URSP rule.

12. The method as claimed in claim 11, wherein the rule-based mode comprises:
assigning one of a selected value or an unselected value to either one of the primary SIM or the secondary SIM upon matching of the URSP rule;
wherein the selected value being assigned upon determining presence of the URSP rule for the application and the UE establishing the PDU session;
wherein the unselected value being assigned upon determining absence of the URSP rule for the application and failure of the UE to establish the PDU session; and
training the rule-based mode to select switching of the data session of the application to either one of the primary SIM or the secondary SIM based on the assigned one of the selected value or the unselected value.

13. The method as claimed in claim 11, wherein the learning-based mode comprises:
determining a state of the primary SIM and the secondary SIM, wherein the state is indicative of measuring a traffic characteristics for a specified time;
determining a probability distribution between the primary SIM and the secondary SIM, based on the state;
switching of the data session of the application to either one of the primary SIM or the secondary SIM based on the probability distribution.

14. A system for a data session switching for an application in a user equipment (UE) with a dual subscriber identity module (SIM), the system comprising:
a memory including instructions; and
a processor configured to:
determine a User Equipment Route Selection Policy (URSP) rule for a primary SIM and a secondary SIM, wherein the primary SIM is configured as Default Data Subscription (DDS) providing the data session for the application running on the UE
detect a trigger for switching the data session of the application to the secondary SIM based on determination of the URSP rule, wherein the trigger includes one of a matching traffic descriptor a dedicated network slice, one or more stored Quality of Service (QoS) rule and a user preference;
configure the secondary SIM for the DDS based on the trigger; and
switch the data session of the application to the secondary SIM for continuing the data session in response to the configuration.

15. The system as claimed in claim 14, wherein the processor is further configured to:
establish the data session for the application by the UE prior to determining the URSP rule for the primary SIM and the secondary SIM, the processor being further configured to:
identify whether the application is one of a first type or a second type, wherein the first type is indicative of the application configured to establish the data session with one of a dedicated slice, a dedicated Data Network Name (DNN), an Local Area Data Network (LADN), and a dedicated operator, and wherein the second type is indicative of the application configured to establish the data session only with one of a specified type of slice, a specified type of DNN, a specified type of LADN, and a specified type of operator, wherein the application is supported through anyone one of a data connection type;
identify one of the primary SIM and the secondary SIM configured for supporting the application for establishing the data session based on the type of the application; and
establish the data session for the application with identified one of the primary SIM and the secondary SIM.

16. The system as claimed in claim 14, wherein the processor is further configured to:
assign a binary value to each of the primary SIM and the secondary SIM, wherein assigning the binary value comprises:
assigning a first numeral value in response to determining a mismatch of the URSP rule with the application and assigning a second numeral value in response to determining a match of the URSP rule with the application; and
selecting one of the primary SIM and the secondary SIM for establishing the data session for the application based on the assigned binary value.

17. The system as claimed in claim 14, wherein the processor is further configured to:
define one of a rule-based mode and a learning-based mode to switch the data session of the application to either one of the primary SIM or the secondary SIM based on determining the URSP rule.

18. The system as claimed in claim 14, wherein the processor is further configured to:
assign one of a selected value or an unselected value to either one of the primary SIM or the secondary SIM based on matching of the URSP rule,
wherein the selected value being assigned upon determining presence of the URSP rule for the application and the UE establishing the PDU session,
wherein the unselected value being assigned upon determining absence of the URSP rule for the application and failure of the UE to establish the PDU session; and
train the rule-based mode to select switching of the data session of the application to either one of the primary SIM or the secondary SIM based on the assigned one of the selected value or the unselected value.

19. The system as claimed in claim 14, wherein the processor is further configured to:
determine a state of the primary SIM and the secondary SIM, wherein the state is indicative of measuring a traffic characteristics for a specified time;
determine a probability distribution between the primary SIM and the secondary SIM, based on the state; and
switch of the data session of the application to either one of the primary SIM or the secondary SIM based on the probability distribution.
